(19) United States
(12) Patent Application Publication
(10) Pub. No.: US 2007/0166526 A1
(43) Pub. Date: Jul. 19, 2007

(54) Composite structure

(76) Inventors: Philippe Myard, Collonge Au Mont D'Or (FR); Jean-Francois Jacqucs Briois, Gauchy (FR)

Correspondence Address: Jean-Louis Seugnet;Rhodia Inc, Legal Department, 8 Cedar Brook Drive CN 7500, Cranbury, NJ, 08512-7500, US

(21) Appl. No.: 10/573,016

(22) PCT Filed: Sep. 17, 2004
(86) PCT No.: PCT/FR04/02357

§ 371 Date: Jan. 22, 2007

(30) Foreign Application Priority Data
Sep. 23, 2003 (FR) 03-11114

(51) Int. Cl. B32B 3/26

(52) U.S. Cl. 428/304.4

(57) ABSTRACT

The invention relates to a composite structure, in particular to a sandwich structure comprising a structural layer (C1), a lightweight layer (C2) and optionally a reinforcing component made of rigid or semi-rigid foam and optionally a structural layer (C3). Said invention relates, in particular to a composite structure comprising a polyamide-based foam layer (C2), to a method for the production and use thereof.

The present invention relates to a composite structure, notably a sandwich structure comprising a structural layer C1, a weight-reducing and possibly reinforcing layer C2, of rigid or semirigid foam, and optionally a structural layer C3. The invention relates more particularly to a composite structure comprising a layer C2 of polyamide-based foam, a method of manufacture and a use of said structure.

Composite structures, and notably sandwich structures, are used in many areas such as aeronautics, the automobile industry and the sports and leisure industry. These structures are used for making sports articles such as skis or for making various surfaces, such as special floors, partitions, vehicle bodies, billboards etc. Composite structures can also be used for making roofs of verandas, terraces, roofing, balconies, galleries, walls (cladding) etc. In aeronautics, these structures are used notably for fairings (fuselage, wing, tail plane). In the automobile industry they are used for example for floors and for supports such as rear parcel shelves etc.

High-performance composite structures are required for various applications. Composite structures need to be developed that have good properties notably of rigidity, lightness and easy recycling.

Fabrication of composite structures with an internal weight-reducing layer having a honeycomb structure is already known. A honeycomb structure with cells of hexagonal shape is known, for example. Said structure notably has the following drawbacks: the cost of manufacture of this complex structure is high; moreover, undesirable effects due to the very nature of this structure may be observed, notably effects of cell filling if there is infiltration of water, and the “telegraph effect”.

Composite structures with an internal weight-reducing layer of polyurethane foam are also known. However, rigid polyurethane foams have a tendency to crumble and in addition have low impact and fatigue strength. Their service temperature range is also limited.

The present invention therefore proposes a composite structure that does not have these drawbacks, and notably displays good properties of rigidity, lightness and ease of recycling.

The present invention therefore relates to a composite structure, notably a sandwich structure, comprising at least:
a structural layer C1
a weight-reducing and possibly reinforcing layer C2, of rigid or semirigid foam
optionally a structural layer C3
   the foam being a polyamide-based foam

According to a particular embodiment of the invention, the composite structure is a sandwich structure comprising two outer structural layers C1 and C3, and an internal weight-reducing layer C2.

The structural layer of the composite structure is preferably in the form of plate or sheet. A plate can be formed from several sheets having different orientations relative to one another, in order to obtain a plate displaying good mechanical properties. The plates or sheets can have variable dimensions. As an example, we may mention as dimensions of plates that may be suitable within the scope of the invention, a plate with a length of 2.5 m and a width of 1 m.

The structural layer can be of metal such as aluminum, of metal alloy such as steel etc. The plates can be painted or covered with any suitable coating.

The thickness of the structural layer of the composite structure of the invention is preferably between 0.2 and 3 mm.

The outer layer of the composite structure of the invention can comprise several layers.

The total thickness of the composite structure of the invention is preferably between 3 and 50 mm.

The density of the foam of the structure of the invention is preferably less than 300 kg/m³, and preferably between 30 and 200 kg/m³. Lower density of the foam means the composite structure will be lighter, which offers many advantages.

The Young's modulus or modulus of elasticity in compression of the foam of the composite structure of the invention is preferably greater than or equal to 30 MPa. Said modulus can be measured by a method described below in the experimental section. The foam of the structure of the invention preferably has good compressive strength, enabling it to preserve its integrity and its properties during possible crushing of the structure. Such crushing may occur in certain fields of application of the structure, for example during violent impacts in particular.

The polyamide of the invention is a polyamide of the type such as those obtained by polycondensation from dicarboxylic acids and diamines, or of the type such as those obtained by polycondensation of lactams and/or amino acids. The polyamide of the invention can be a blend of polyamides of different types and/or of the same type, and/or copolymers obtained from different monomers corresponding to the same type and/or to different types of polyamide.

The polyamide is preferably selected from the group comprising PA 4.6, PA 6, PA 6.6, PA 6.9, PA 6.10, PA 6.12, PA 6.36, PA 11, PA 12 or a semi-aromatic, semicrystalline polyamide or copolyamide selected from the group comprising the polyphthalamides, and blends of these polymers and of their copolymers.

According to a preferred embodiment of the invention, the polyamide is selected from nylon 6, nylon 6,6, their blends and copolymers.

The rigid or semirigid polyamide foam of the invention can be obtained by any method known to a person skilled in the art.

It can be obtained by injecting gas under pressure into the polyamide in the molten state.

The foam can also be obtained by incorporating blowing agents—thermally unstable fillers—in the polyamide in the molten state, which release a gas during their decomposition.

It is also possible to obtain the polyamide foam of the invention by adding, to the polyamide in the molten state, compounds that dissolve in the melt, the foam being obtained by volatilization of these compounds.

The foam can also be obtained by means of a chemical reaction that releases gas, such as carbon dioxide, for example by bringing into contact isocyanates and lactams as well as bases for activating anionic polymerization.

The polyamide foam of the invention is preferably obtained from a mixture of polyamide and polycarbonate. The foam is obtained by a chemical route, i.e. notably by chemical reaction between the polyamide and the polycarbonate.

The polycarbonate of the blend is preferably a polycarbonate comprising aromatic rings of formula: 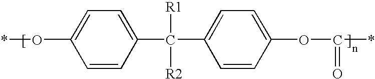
in which R₁ and R₂, which may be identical or different, are hydrogen atoms, halogen atoms or alkyl or haloalkyl radicals containing between 1 and 5 carbon atoms, and each aromatic ring can be substituted by alkyl or haloalkyl radicals having between 1 and 5 carbon atoms.

n is an integer between 40 and 300, preferably between 20 and 300.

The molecular weight of the polycarbonate of the invention is preferably between 5000 and 80000, and more preferably between 10000 and 40000.

Advantageously, the blend has 0.5 to 20 wt. % of polycarbonate relative to the polyamide, and preferably 5 to 15 wt. %.

The blend of polyamide and polycarbonate of the invention can also comprise, in addition to a polyamide and a polycarbonate, blowing agents which will make it possible to amplify the foaming during preparation of the foam from the blend. Said blowing agents are familiar to a person skilled in the art.

The blend can also comprise other additives that are suitable for further processing of the foam, such as surfactants, nucleating agents such as talc, plasticizers etc. These additives are familiar to a person skilled in the art.

The blend can also comprise reinforcing fillers such as fibers of glass or of carbonate, flatting agents such as titanium dioxide or zinc sulfide, pigments, colorants, heat or light stabilizers, bioactive agents, antisoiling agents, antistatic agents, fireproofing agents, high-density or low-density fillers etc. This list is not intended to be exhaustive.

The blend of polyamide and polycarbonate is made by any method known to a person skilled in the art for making a blend, for example by intimate mixing of powders of polyamide and of polycarbonate, or by mixing granules of polyamide and of polycarbonate. The blend can be prepared in the molten state, for example in an extrusion device.

According to a particular embodiment of the invention, the foam is obtained by heating the polyamide/polycarbonate blend.

The temperature reached by heating must be sufficient notably to cause reaction between the polyamide and the polycarbonate, as well as release of gas, leading to the formation of foam.

The temperature reached by heating is preferably greater than or equal to the melting point of the polyamide.

A screw mixer can be used during heating.

Preferably a twin-screw extruder is used for mixing and heating.

Layer C2, made of foam, is generally in the form of plate. The plates can be prepared by any method known to a person skilled in the art. For example, when the foam is prepared by mixing and heating in an extrusion device, the plate shape can be produced by means of a lay-flat device at the extruder head outlet.

According to a particular embodiment of the invention, the structural layer can comprise a thermoplastic or thermosetting polymer matrix, generally reinforced with reinforcing fibers, such as fibers of glass, carbon, aramid, polyimide, quartz, sisal, hemp, flax, etc. The matrix is preferably a thermoplastic polymer.

Preferably, the matrix is a thermoplastic polymer comprising an aliphatic and/or semicrystalline polyamide or copolyamide, preferably selected from the group comprising PA 4.6, PA 6, PA 6.6, PA 6.9, PA 6.10, PA 6.12, PA 6.36, PA 11, PA 12 or a semi-aromatic, semicrystalline polyamide or copolyamide selected from the group comprising the polyphthalamides, and blends of these polymers and of their copolymers.

Thus, according to this embodiment, the structural layer and the weight-reducing layer of the composite structure of the invention are of polyamide, which offers an advantage notably for the recycling of this type of structure.

According to a preferred embodiment of the structure of the invention, the matrix of the structural layer comprises a polyamide with a star structure comprising:
star-branched macromolecular chains comprising one or more cores and at least three arms or three polyamide segments connected to a core,
linear macromolecular polyamide chains if required.

The star-structured polymer is a polymer comprising macromolecular star chains, and linear macromolecular chains if required. Polymers comprising said star-structured macromolecular chains are described for example in documents FR 2 743 077, FR 2 779 730, EP 0 682 057 and EP 0 832 149. These compounds are known to display improved fluidity relative to linear polyamides.

Advantageously, the star-structured polyamide is of the type of polyamides obtained by copolymerization of a mixture of monomers comprising at least:
a) monomers of the following general formula (I): 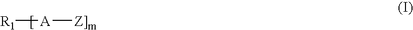
b) monomers of the following general formulas (IIa) and (IIb): 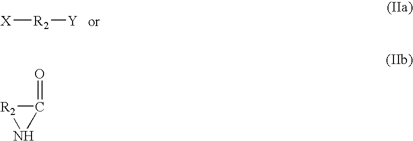
c) optionally monomers of the following general formula (III):
   Z-R₃-Z (III)
   in which:
R₁ is a hydrocarbon radical having at least 2 carbon atoms, linear or cyclic, aromatic or aliphatic and which may contain heteroatoms,
A is a covalent bond or an aliphatic hydrocarbon radical which may contain heteroatoms and has from 1 to 20 carbon atoms,
Z represents a primary amine function or a carboxylic acid function,
Y is a primary amine function when X represents a carboxylic acid function
   or
Y is a carboxylic acid function when X represents a primary amine function,
R₂ and R₃, which may be identical or different, represent substituted or unsubstituted, aliphatic, cycloaliphatic or aromatic hydrocarbon radicals having from 2 to 20 carbon atoms and which may contain heteroatoms,
m represents an integer between 3 and 8.

Preferably, the compound of formula (I) is selected from 2,2,6,6-tetra-(β-carboxyethyl)-cyclohexanone, trimesic acid, 2,4,6-tri-(aminocaproic acid)-1,3,5-triazine and 4-aminoethyl-1,8-octanediamine.

The invention also relates to a method of manufacture of the composite structure described above. The method comprises a stage of assembly of at least the following elements:
(C1′): a structural layer or a precursor of said layer
(C2′): a weight-reducing and optionally reinforcing layer, of polyamide-based foam or a precursor of said foam
(C3′): optionally a structural layer or a precursor of said layer

The foam precursor can be an expandable polyamide composition, for example a blend of polyamide and polycarbonate as described above. By expandable polyamide composition we mean a polyamide composition that can form a foam under certain conditions of temperature and/or pressure. In general the expandable polyamide composition comprises a polyamide and an expanding agent. The expanding agent can be a gas that can be dispersed or dissolved in the polyamide in the molten state. Any gas known to a person skilled in the art that can be dispersed or dissolved in the polyamide can be used. The gas is preferably inert. The following may be mentioned as examples of a suitable gas within the scope of the invention: nitrogen, carbon dioxide, butane etc.

The expanding agent can also be a blowing agent. Any blowing agent known by a person skilled in the art can be used. It is introduced into the polyamide in accordance with a method known by a person skilled in the art. Diazocarbonamide may be mentioned as an example of a blowing agent.

The expanding agent can also be a volatile compound that can be dissolved in the polyamide in the molten state. Any volatile compound known by a person skilled in the art that can be dissolved in the polyamide can be used. Butanol may be mentioned as an example of a volatile compound that is suitable within the scope of the invention.

Finally, the expanding agent can be a chemical compound that is able to react chemically with the polyamide on heating. A gas is usually generated during this reaction, and this gas is responsible for the expansion of the mixture. The expanding agent can be a polycarbonate, for example.

The expandable polyamide composition can be in the form of powder, of an article (plate) obtained for example by controlled injection molding avoiding the formation of foam, of a mixture in the molten state etc.

The precursor of the structural layer can be an article containing reinforcing fibers. The article can be in the form of continuous or cut threads, strips, mats, of braided, woven or knitted fabrics, fleece, multiaxial materials, nonwovens and/or of complex forms comprising several of the aforementioned forms.

In addition to the reinforcing fibers, the precursor of the structural layer preferably comprises a polymer matrix, for example in the form of powder, film etc. The precursor of the structural layer can be a pre-impregnated article, i.e. a cloth impregnated with a resin, said resin containing a hardening agent with a view to subsequent hardening by heating.

According to a particular embodiment of the invention, the precursor of the structural layer is an article comprising reinforcing threads and/or fibers and threads and/or fibers of polymer matrix.

Everything described previously concerning the polymer matrix of the composite structure of the invention applies here to the precursor, notably everything relating to the nature of the matrix.

By thread we mean a monofilament, a continuous multifilament thread, or a yarn of fibers, obtained from a single type of fibers or from several types of fibers in an intimate mixture. The continuous thread can also be obtained by assembling together several multifilament threads.

By fiber, we mean a filament or an assemblage of cut, cracked or converted filaments.

The article comprising reinforcing threads and/or fibers and threads and/or fibers of polymer matrix can be in the form of continuous or cut threads, strips, mats, of braided, woven or knitted fabrics, fleece, multiaxial materials, nonwovens and/or of complex forms comprising several of the aforementioned forms.

Any method of assembling the various layers can be used within the scope of the method of the invention.

The various elements (C1′), (C2′), and optionally (C3′) can be assembled simultaneously or successively, for example by gluing. Said gluing is performed by any method known by a person skilled in the art for assembling elements of a multilayer composite structure. For example the various elements can be glued with an adhesive film that is compatible with the material of the elements.

According to a particular embodiment of the method of the invention, assembly is carried out by thermoforming or calendering of the various elements (C1′), (C2′) and optionally (C3′) described above. The various elements are thermoformed or calendered simultaneously or successively. For example the assembly of layer (C1′), layer (C3′) and optionally layer (C2′) can be thermoformed or calendered simultaneously. It is also possible to thermoform or calender the assembly of layer (C1′) and layer (C2′), then thermoform or calender layer (C3′) and the assembly of layer (C1′) and layer (C2′).

This stage can be carried out by heating, then cold-pressing of the various elements (deep-drawing).

Generally this stage is carried out with heating and under pressure.

The thermoforming processes used generally employ low pressures (less than 20 bar and optionally under vacuum), temperatures below 270° C., and short times (less than 15 minutes).

This stage notably provides good adhesion between the weight-reducing layer and the structural layer.

According to a particular embodiment of the method of the invention, the temperature during thermoforming or calendering is greater than or equal to the melting point of the polymer matrix of the precursor of the structural layer, when said precursor comprises an article comprising reinforcing fibers and a polymer matrix.

The relatively high melting point of the polyamide of the foam means that high temperatures can be used during production of the composite structures, which is not possible with the known foams. In fact the polyamide foam melts at a higher temperature than the foams of the prior art such as polyurethane foams.

The temperature during thermoforming or calendering is preferably greater than or equal to the melting point of the thermoplastic polymer matrix of the structural layer, when the latter comprises a thermoplastic polymer matrix.

When the structural layer of the composite structure is a plate or a sheet comprising a thermoplastic polymer matrix, assembly of the foam with the structural layer can be effected owing to fusion of the matrix during thermoforming or calendering, which penetrates into the surface pores of the foam, and then performs the role of an adhesive as it solidifies. Moreover, if the temperature of thermoforming or calendering is more or less equal to the temperature of the polyamide of the foam, partial fusion of the foam at the point of contact of the foam and of the structural layer may occur, and this molten portion of foam can also perform the role of an adhesive, as it solidifies.

The invention also relates to the use of the composite structure described above for the production of automobile or aircraft components or for making sports articles such as skis or for the manufacture of building panels.

Other details or advantages of the invention will become clearer from the examples given below purely as a guide.

Test for Measuring the Young's Modulus of the Foam:

The test is performed on a specimen of foam 20 mm in diameter and 25 mm thick, using an INSTRON 1185 testing machine, in conditions of temperature of 23° C. and relative humidity of 50%.

Young's modulus is determined from the stress/strain curve recorded using the testing machine, working with a strain rate of 20 mm/min.

Test for Measuring the Density of the Foam:

The density is measured on specimens machined to the dimensions 100×100×15 mm. These specimens are then weighed on a precision balance, according to standard ASTM D 3748-98.

### EXAMPLES

### Example 1

### Preparation of a Layer C2 of Polyamide Foam

Granules of PA66 marketed by the company Rhodia Engineering Plastic under reference A 216 Naturel® (90% w/w) are mixed with polycarbonate granules marketed by the company Bayer under reference Makrolon 2205® (10% w/w). The mixture is stoved over night under partial vacuum and with nitrogen scavenging. This mixture is used as the feed for a twin-screw extruder equipped with a lip die. The temperature profile of the twin-screw extruder is as follows: (in ° C.) 270-280-280-280-280-280. The rotary speed of the twin-screw extruder is set to 250 rev/min. The extrudate is shaped in a lay-flat device and is cooled on a transport bench before being cut and shaped as plate, for example 10 cm wide and 1 cm thick. The extruder feed rate is 15 kg/h. Said plates are of mean density 0.15. The plates have a Young's modulus of 43.3 MPa. FIG. 1 shows the stress/strain curve of the polyamide foam of Example 1 (curve A), and that of the polymethacrylimide foam PMI (curve B) sold by the company Degussa under reference Rohacell 71 IG® (Young's modulus: 57.9 MPa, density d=0.08), for comparison. On this graph, the abscissa corresponds to the strain (%) and the ordinate to the stress (mPa). In contrast to the polyamide foam, the polymethacrylimide foam PMI breaks beyond 27% strain.

### Examples 2 and 3

### Preparation of a Structural Layer: Semifinished Plate of Star-Structured Nylon 6 and Reinforcing Threads

Matrix used: star-structured nylon 6, obtained by copolymerization from caprolactam in the presence of 0.5 mol. % of 2,2,6,6-tetra-(β-carboxyethyl)cyclohexanone, by a method described in document FR 2743077, comprising about 80% of star-structured macromolecular chains and 20% of linear macromolecular chains, with a melt flow index measured at 275° C. under 1000 g of 55 g/10 min.

A series of tests was carried out with a multifilament thread of star-structured nylon 6, having a thread count between 3 and 8 dtex and strength of approximately 15-20 cN/tex. Said multifilament thread is assembled, in an operation of multiaxial weaving, with a high-performance continuous carbon reinforcing thread, comprising 12 000 filaments (Example 2), or with a glass reinforcing thread, having a count of 600 tex (Example 3). To verify the high fluidity of the matrix in the molten state, multiaxial fabrics are made from unit layers, defined as follows:

Unit Layer

Ply No. 1: reinforcing thread−orientation: −45°
Ply No. 2: reinforcing thread−orientation: +45°
Ply No. 3: star-structured nylon 6 thread (matrix)−orientation: 90°

A layered composite is then made by placing several unit layers (between 2 and 10) of fabric obtained in the plate-shaped mold, under a heated-platen press for a time of 1-3 minutes, at a pressure between 1 and 20 bar and a temperature above the melting point of the star-structured nylon 6 (230-260° C.). After cooling to a temperature of 50-60° C., the composite is stripped from the mold. The proportion of reinforcement by weight is then between 60 and 70%.

### Example 4

### Preparation of a Sandwich Composite Structure with Two Outer Structural Layers C1 and C3, and a Weight-Reducing Internal Layer C2

Two layered composites according to Example 2 (layers C1 and C3) are placed on either side of a layer C2 of foam prepared according to Example 1. The assembly is placed between the platens of a heated-platen press of dimensions 270 mm×270 mm at 240° C. for 10 minutes under 15 bar, then cooled under pressure to 130° C. and removed from the mold. A sandwich structure is obtained with very good integrity of the foam and good cohesion between the layers.

### Example 5

### Preparation of a Sandwich Composite Structure with Two Outer Structural Layers C1 and C3, and a Weight-Reducing Internal Layer C2

Two layered composites according to Example 3 (layers C1 and C3) are placed on either side of a layer C2 of foam prepared according to Example 1. The assembly is placed between the platens of a heated-platen press of dimensions 270 mm×270 mm at 240° C. for 10 minutes under 15 bar, then cooled under pressure to 130° C. and removed from the mold. A sandwich structure is obtained with very good integrity of the foam and good cohesion between the layers.

### Example 6

### Preparation of a Sandwich Composite Structure with Two Outer Structural Layers C1 and C3, and a Weight-Reducing Internal Layer C2

Two aluminum plates, of dimensions 270×270 mm and thickness of 1 mm, and from which the protective layer has been removed (layers C1 and C3), are placed on either side of a layer C2 of foam prepared according to Example 1. The assembly is placed between the platens of a heated-platen press of dimensions 270 mm×270 mm at 240° C. for 10 minutes under 15 bar, then cooled under pressure to 130° C. and removed from the mold. A sandwich structure is obtained with very good integrity of the foam and good cohesion between the layers.

1-28. (canceled)

29. A composite structure comprising at least:
a structural layer C1;
a weight-reducing layer C2 of rigid or semi rigid foam; and
optionally a structural layer C3
wherein the foam is a polyamide-class foam.

30. The composite structure as claimed in claim 29, being a sandwich structure comprising two outer structural layers C1 and C3, and a weight-reducing internal layer C2.

31. The composite structure as claimed in claim 30, wherein at least one structural layer is a plate or a sheet.

32. The composite structure as claimed in claim 31, wherein the plate or sheet of metal is of a metal alloy, optionally steel.

33. The composite structure as claimed in claim 29, wherein the structural layer has a thickness of between 0.2 and 3 mm.

34. The composite structure as claimed in claim 29, wherein the composite layer has a thickness of between 3 and 50 mm.

35. The composite structure as claimed in claim 29, having a density of the foam of less than 300 kg/m³, and optionally between 30 and 200 kg/m³.

36. The composite structure as claimed in claim 29, wherein the foam has a Young's modulus (modulus of elasticity in compression) greater than or equal to 30 MPa.

37. The composite structure as claimed in claim 29, wherein the polyamide foam is obtained by injecting gas into the polyamide and/or by incorporating volatile compounds, blowing agents and/or a compound reacting with the polyamide to form gas, in the polyamide.

38. The composite structure as claimed in claim 37, wherein the foam is obtained from a mixture of polyamide and polycarbonate.

39. The composite structure as claimed in claim 38, wherein the polycarbonate is a polycarbonate comprising aromatic rings of formula: 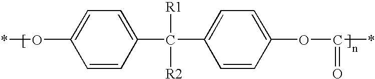
in which R₁ and R₂, which are identical or different, are hydrogen atoms, halogen atoms or alkyl or haloalkyl radicals having between 1 and 5 carbon atoms, and each aromatic ring optionally being substituted by alkyl or haloalkyl radicals having between 1 and 5 carbon atoms; and n is an integer between 40 and 300.

40. The composite structure as claimed in claim 39, wherein the polycarbonate has a molecular weight of between 5000 and 80000.

41. The composite structure as claimed in claim 38, wherein the mixture contains 0.5 to 20 wt. % of polycarbonate relative to the polyamide, optionally 5 to 15 wt. %.

42. The composite structure as claimed in claim 38, wherein the foam is obtained by heating the mixture of polyamide and polycarbonate at a temperature greater than or equal to the melting point of the polyamide.

43. The composite structure as claimed in claim 29, wherein at least one structural layer is a plate or a sheet comprising a thermoplastic or thermosetting polymer matrix.

44. The composite structure as claimed in claim 43, wherein at least one structural layer is a plate or a sheet comprising a thermoplastic or thermosetting polymer matrix and reinforcing fibers, optionally glass, carbon, aramid, polyimide, quartz, sisal, hemp, or flax fibers.

45. The composite structure as claimed in claim 43, wherein the matrix comprises a star-structured polyamide comprising:
star-structured macromolecular chains comprising one or more cores and at least three arms or three polyamide segments connected to the core, and
optionally, linear macromolecular polyamide chains.

46. The composite structure as claimed in claim 45, wherein the star-structured polyamide is of the type of polyamides obtained by copolymerization of a mixture of monomers comprising at least:
a) monomers of the following general formula (I): 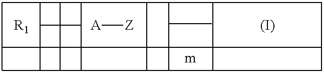
b) monomers of the following general formulas (IIa) and (IIb): 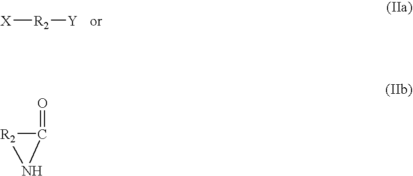
c) and optionally monomers of the following general formula (III):
Z-R₃-Z (III)
wherein:
R₁ is a hydrocarbon radical having at least 2 carbon atoms, linear or cyclic, aromatic or aliphatic optionally containing heteroatoms,
A is a covalent bond or an aliphatic hydrocarbon radical optionally containing heteroatoms and has from 1 to 20 carbon atoms,
Z represents a primary amine function or a carboxylic acid function,
Y is a primary amine function when X represents a carboxylic acid function
or
Y is a carboxylic acid function when X represents a primary amine function,
R₂ and R₃, which are identical or different, represent optionally substituted aliphatic, cycloaliphatic or aromatic hydrocarbon radicals having from 2 to 20 carbon atoms optionally containing heteroatoms, and
m represents an integer between 3 and 8.

47. A method of production of the composite structure as defined in claim 29, comprising the step of assembly of at least the following elements:
(C1′): a structural layer or a precursor of said layer;
(C2′): a weight-reducing layer of polyamide-based foam or a precursor of said foam; and
optionally (C3′): a structural layer or a precursor of said layer.

48. The method as claimed in claim 47, wherein the precursor of the foam is a powder or an article comprising an expandable polyamide composition containing polyamide and an expanding agent.

49. The method as claimed in claim 48, wherein the expanding agent is a polycarbonate.

50. The method as claimed in claim 47, wherein the precursor of at least one structural layer is an article containing reinforcing fibers.

51. The method as claimed in claim 50, wherein the precursor of at least one structural layer comprises:
an article containing reinforcing fibers; and
a polymer matrix

52. The method as claimed in claim 50, wherein the precursor of at least one structural layer is an article containing reinforcing threads and/or fibers and threads and/or fibers of polymer matrix.

53. The method as claimed in claim 52, wherein the article is in the form of continuous threads, cut threads, strips, mats, of braided, woven fabrics, knitted fabrics, fleece, multiaxial materials, or nonwovens.

54. The method as claimed in claim 47, wherein the assembly is carried out by thermoforming or calendering of the various elements (C1′), (C2′) and optionally (C3′), the various elements being thermoformed or calendered simultaneously or successively.

55. The method as claimed in claim 53, wherein the thermoplastic polymer matrix of the precursor of at least one structural layer is a thermoplastic matrix and in that the temperature during thermoforming or calendering is greater than or equal to the melting point of the thermoplastic matrix.
